(19) United States
(12) Patent Application Publication
(10) Pub. No.: US 2024/0411129 A1
(43) Pub. Date: Dec. 12, 2024

(54) HEAD-UP DISPLAY DEVICE FOR RAIL TRANSPORTATION

(71) Applicant: SHENZHEN RAYTHINK TECHNOLOGY CO., LTD., Shenzhen (CN)

(72) Inventor: RUI LU, Shenzhen (CN)

(21) Appl. No.: 18/512,031

(22) Filed: Nov. 17, 2023

(30) Foreign Application Priority Data
Jun. 7, 2023 (CN) 202310666608.7

(51) Int. Cl. G02B 27/01

(52) U.S. Cl. CPC G02B 27/0101; G02B 27/0149; G02B 2027/0154

(57) ABSTRACT

The present disclosure provides a head-up display device for rail transportation, including: a base plate assembly; a light source assembly, configured to emit an incident light; a first reflector assembly, disposed on a same side of the base plate assembly as the light source assembly and on a light path of the incident light, to receive the incident light and emit a reflected light; a second reflector assembly, disposed on a side of the base plate assembly away from the first reflector assembly and on a light path of the reflected light, to receive the reflected light and emit a first diffused light; and a third reflector assembly, disposed on a same side of the base plate assembly as the second reflector assembly and disposed on a light path of the first diffused light, to receive the first diffused light and form a projected image.

### CROSS REFERENCE TO RELATED APPLICATION

The present disclosure claims priority of Chinese Patent Applications No. 202310666608.7, filed on Jun. 7, 2023, the entire contents of which are hereby incorporated by reference in their entirety.

### TECHNICAL FIELD

The present disclosure relates to the technical field of head-up displays, and in particular to a head-up display device for rail transportation.

### BACKGROUND

Head Up Display (HUD) is a driver-centered, blind-operated, multifunctional instrument panel. Its role is to project important driving information, such as speed and navigation, onto a windshield in front of the driver, such that the driver can try to see the important driving information, such as speed and navigation, without lowering or turning his/her head, and his/her sight without leaving the front of the car, which improves driving safety.

In the related art, a head-up display device is generally adopted with a point light source to emit light to a diffusion sheet, for forming a diffused light. Finally, the diffused light passes through a polarizer to form an image, which requires that both the diffusion sheet and the polarizer be arranged in the light path of the point light source, thereby resulting in the head-up display device having a larger size in the direction of the light path of the point light source.

### SUMMARY OF THE DISCLOSURE

The present disclosure focuses on providing a head-up display device for rail transportation.

To solve the above technical problem, the present disclosure specifically provides a head-up display device for rail transportation, including: a base plate assembly, defining a first light outlet; a light source assembly, connected to the base plate assembly and configured to emit an incident light; a first reflector assembly, disposed on a same side of the base plate assembly as the light source assembly and on a light path of the incident light, so as to enable the first reflector assembly to receive the incident light and emit a reflected light directed toward the first light outlet; a second reflector assembly, disposed on a side of the base plate assembly away from the first reflector assembly and on a light path of the reflected light, so as to enable the second reflector assembly to receive the reflected light and emit a first diffused light; and a third reflector assembly, disposed on a same side of the base plate assembly as the second reflector assembly and disposed on a light path of the first diffused light, so as to enable the third reflector assembly to receive the first diffused light and form a projected image.

In some embodiments, the base plate assembly includes a base and a base plate; the base defines a first sub-port, the light source assembly is connected to the base, and the base plate is disposed on a side of the base away from the light source assembly and defines a second sub-port; the first sub-port and the second sub-port together define the first light outlet; the second reflector assembly and the third reflector assembly are connected to the base plate respectively.

In some embodiments, the base plate is movably disposed relative to the base, to enable adjustment of a light position and/or a light angle of the first diffused light when the base plate is moved relative to the base.

In some embodiments, the base plate assembly further includes a rocker handle, the rocker being connected to the base and the base plate, respectively, so as to enable the rocker handle to drive the base plate to move relative to the base when the rocker handle is rotated.

In some embodiments, the rocker handle includes a rocker body and a filament rod body; the rocker body is rotatably connected to the base, and the filament rod body is fixedly connected to the rocker body and passes through the base plate, so as to enable the base plate to move in an extension direction of the filament rod body when the rocker body is rotated relative to the base.

In some embodiments, the first reflector assembly includes a first reflector holder and a first reflector; the first reflector holder is disposed on a same side of the base plate assembly as the light source assembly and connected to the base plate assembly; the first reflector is arranged on the first reflector holder and is disposed on the light path of the incident light.

In some embodiments, the first reflector is arranged at an inclination relative to a direction of the light path of the incident light.

In some embodiments, the second reflector assembly includes a diffusion mechanism and a second reflector mechanism; the diffusion mechanism is disposed on the light path of the reflected light to cause the reflected light to pass through the diffusion mechanism and form a second diffused light; the second reflector mechanism is disposed on a light path of the second diffused light, so as to enable the second reflector mechanism to receive the second diffused light and emit the first diffused light.

In some embodiments, the second reflector mechanism includes a second reflector holder and a second reflector; the second reflector is arranged on the second reflector holder and defines a diffusion space, that is in communication with the first light outlet, with the second reflector holder; the diffusion mechanism is disposed within the diffusion space.

In some embodiments, the third reflector assembly includes a third reflector mechanism and a polarizing assembly; the third reflector mechanism is disposed on the light path of the first diffused light, so as to enable the third reflector mechanism to receive the first diffused light and emit a third diffused light; the polarizing assembly is disposed on a light path of the third diffused light, to cause the third diffused light to pass through the polarizing assembly and form the projected image.

### BRIEF DESCRIPTION OF THE DRAWINGS

In order to more clearly illustrate the technical solutions in the embodiments of the present disclosure, the accompanying drawings to be used in the description of the embodiments will be briefly introduced below, and it will be obvious that the accompanying drawings in the following description are only some of the embodiments of the present disclosure, and that for those skilled in the art, other accompanying drawings can be obtained according to these drawings without putting in creative labor.

FIG. 1 is a perspective structural schematic view of a head-up display device for rail transportation according to an embodiment of the present disclosure.

FIG. 2 is a schematic view of a disassembled structure of the head-up display device shown in FIG. 1.

FIG. 3 is a perspective structural schematic view of a base plate assembly in FIG. 2.

FIG. 4 is a schematic view of a disassembled structure of the base plate assembly shown in FIG. 3.

FIG. 5 is a schematic view of a light path of a light path apparatus in FIG. 1.

FIG. 6 is a schematic view of a disassembled structure of a light source assembly in FIG. 2.

FIG. 7 is a schematic view of a disassembled structure of a first reflector assembly in FIG. 2.

FIG. 8 is a perspective structural schematic view of a second reflector assembly in FIG. 2.

FIG. 9 is a schematic view of a disassembled structure of the second reflector holder in FIG. 8.

FIG. 10 is a schematic view of a disassembled structure of a diffusion mechanism in FIG. 8.

FIG. 11 is a cross-sectional schematic view of the diffusion mechanism and the second reflector holder in FIG. 10 in an F-F upward direction.

FIG. 12 is a perspective structural schematic view of a third reflector mechanism in FIG. 2.

FIG. 13 is an enlarged schematic view of part M in FIG. 4.

FIG. 14 is a cross-sectional schematic view of a base and a base plate in FIG. 3 in an N-N upward direction.

FIG. 15 is a perspective structural schematic view of a limiting member in FIG. 13.

FIG. 16 is a perspective structural schematic view of a rocker handle in FIG. 3.

### DETAILED DESCRIPTION

The present disclosure is described in further detail below in conjunction with the accompanying drawings and embodiments. In particular, it is noted that the following embodiments are only intended to illustrate the present disclosure, but do not limit the scope of the present disclosure. Similarly, the following embodiments are only some but not all of the embodiments of the present disclosure, and all other embodiments obtained by those skilled in the art without creative labor fall within the scope of the present disclosure.

The terms “first”, “second”, and “third” in the present disclosure are used for descriptive purposes only, and are not to be construed as indicating or implying relative importance or implicitly specifying the number of technical features indicated. It is not to be understood as indicating or implying relative importance or implicitly specifying the number of technical features indicated. Thus, a feature defined with “first”, “second”, “third” may include at least one such feature, either explicitly or implicitly. In the description of the present disclosure, “plurality” means at least two, in the manner of two, three, etc., unless otherwise expressly and specifically limited. All directional indications (e.g., up, down, left, right, forward, back . . . ) in the present disclosure are intended only to explain the relative positional relationship, movement, etc., between components in a particular attitude (as shown in the accompanying drawings), and the directional indications are changed accordingly if the particular attitude is changed. Furthermore, the terms “including” and “having” and any variations thereof are intended to cover non-exclusive inclusion. A process, method, system, product, or apparatus that includes a series of steps or units is not limited to the listed steps or units, but may further include steps or units that are not listed or other steps or units that are inherent to the process, method, product, or apparatus.

Reference to “embodiments” herein implies that particular features, structures, or characteristics described in conjunction with the embodiments may be included in at least one embodiment of the present disclosure. The presence of the phrase at various points in the specification does not necessarily refer to the same embodiment, nor is it a separate or alternative embodiment that is mutually exclusive of other embodiments. It is understood by those skilled in the art, both explicitly and implicitly, that the embodiments described herein may be combined with other embodiments.

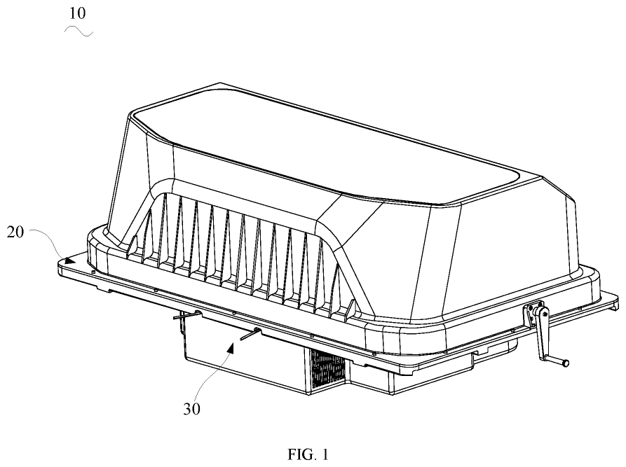

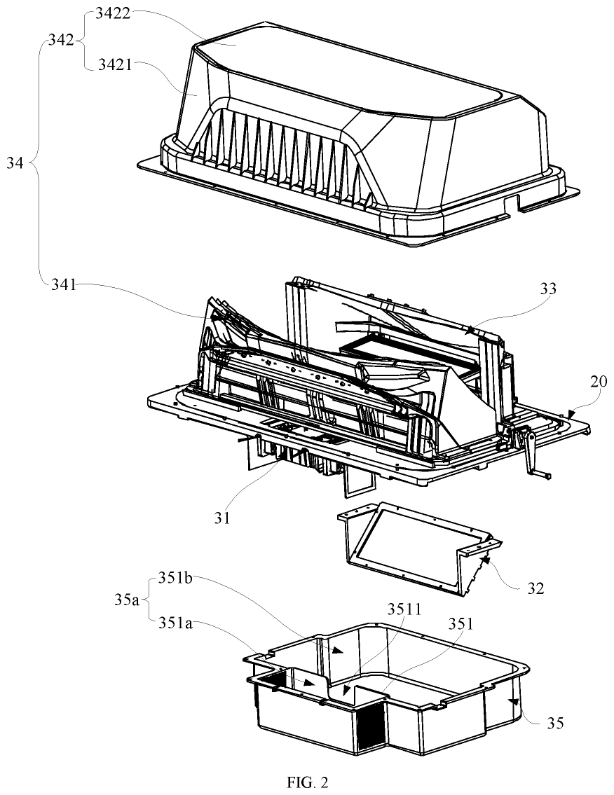

Referring together to FIGS. 1 and 2, FIG. 1 is a perspective structural schematic view of a head-up display device 10 for rail transportation according to an embodiment of the present disclosure, and FIG. 2 is a schematic view of a disassembled structure of the head-up display device 10 shown in FIG. 1. The head-up display device 10 in the embodiments includes a base plate assembly 20 and a light path apparatus 30.

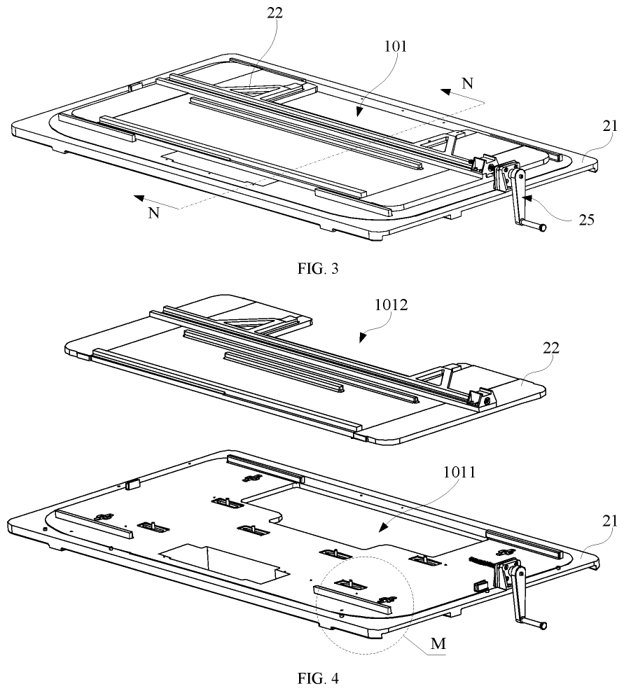

Referring together to FIGS. 3 and 4, FIG. 3 is a perspective structural schematic view of the base plate assembly 20 in FIG. 2, and FIG. 4 is a schematic view of a disassembled structure of the base plate assembly 20 shown in FIG. 3. The base plate assembly 20 defines a first light outlet 101.

Specifically, in the embodiments, the base plate assembly 20 includes a base 21 and a base plate 22; the base 21 defines a first sub-port 1011, the base plate 22 defines a second sub-port 1012, and the first sub-port 1011 and the second sub-port 1012 together define the first light outlet 101.

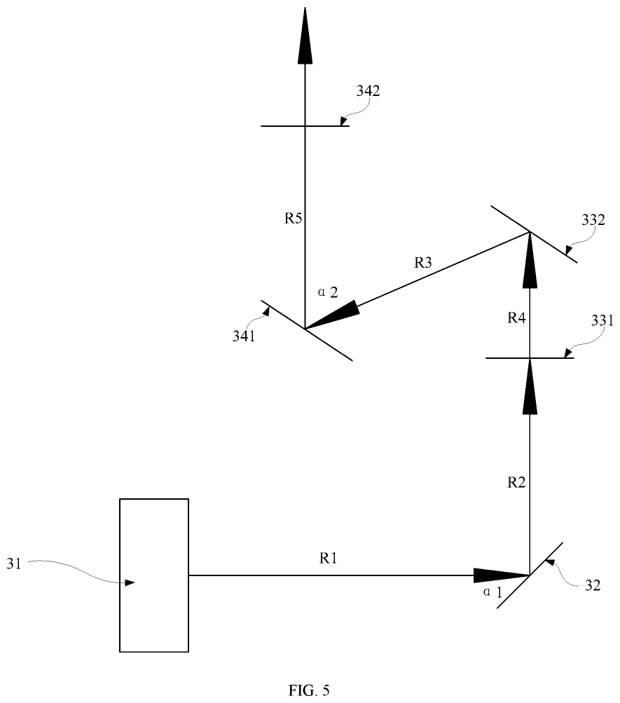

Referring to FIGS. 2 and 5 together, FIG. 5 is a schematic view of a light path of the light path apparatus 30 in FIG. 1. The light path apparatus 30 includes a light source assembly 31, a first reflector assembly 32, a second reflector assembly 33, and a third reflector assembly 34.

The light source assembly 31 is connected to the base plate assembly 20 and is configured to emit an incident light R1. In the embodiments, the light source assembly 31 is connected to the base 21, and the base plate 22 is arranged on a side of the base 21 away from the light source assembly 31.

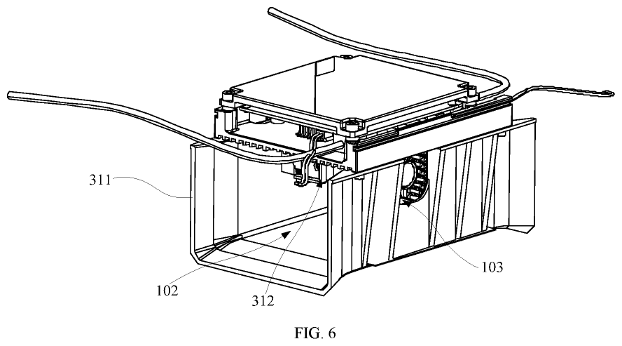

Referring to FIG. 6, FIG. 6 is a schematic view of a disassembled structure of the light source assembly 31 in FIG. 2. The light source assembly 31 includes a light source shell 311 and a light source 312. The light source shell 311 defines a mounting space 102 and a second light outlet 103 in communication with the mounting space 102. The light source 312 is disposed inside the mounting space 102, and the incident light R1 emitted by the light source 312 is emitted from the light source shell 311 through the second light outlet 103.

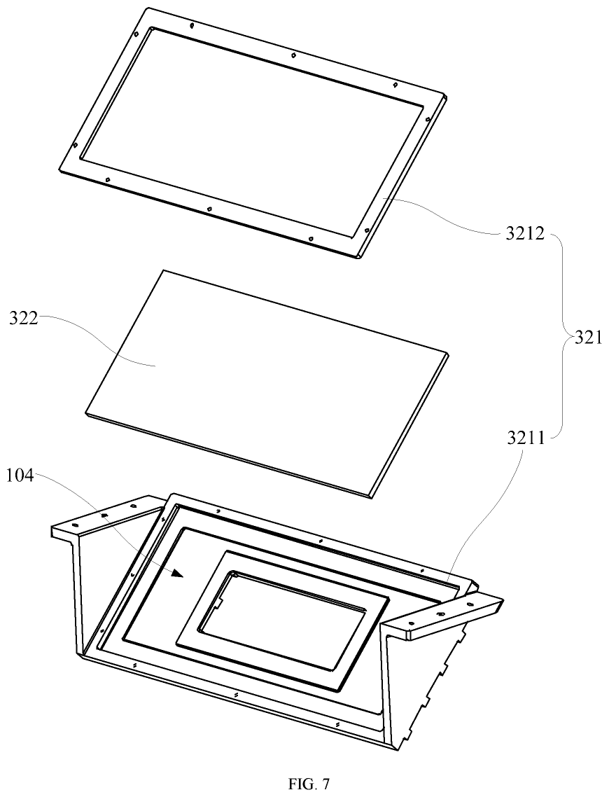

Referring to FIG. 2, FIG. 5, and FIG. 7 together, FIG. 7 is a schematic view of a disassembled structure of the first reflector assembly 32 in FIG. 2. The first reflector assembly 32 and the light source assembly 31 are disposed on a same side of the base plate assembly 20 and are disposed on a light path of the incident light R1, so as to enable the first reflector assembly 32 to receive the incident light R1 and emit a reflected light R2 directed toward the first light outlet 101.

Specifically, the first reflector assembly 32 includes a first reflector holder 321 and a first reflector 322. The first reflector holder 321 and the light source assembly 31 are disposed on a same side of the base plate assembly 20 and are connected to the base plate assembly 20. That is, in the embodiments, the first reflector holder 321 is connected to the base 21, and the first reflector 322 is arranged on the first reflector holder 321 and is disposed on the light path of the incident light R1, so as to enable the first reflector 322 to receive the incident light R1 and emit the reflected light R2.

The first reflector holder 321 includes a first clamping member 3211 and a second clamping member 3212. The first clamping member 3211 is connected to the base 21 and disposed opposite to the second clamping member 3212 to jointly clamp the first reflector 322.

The first clamping member 3211 defines an accommodating slot 104, the first reflector 322 is disposed in the accommodating slot 104, and the second clamping member 3212 covers the accommodating slot 104. In practice, the first reflector 322 may be placed in the accommodating slot 104 before the second clamping member 3212 is placed covering the accommodating slot 104.

In some embodiments, the second clamping member 3212 is detachably connected to the first clamping member 3211, such as by a bolt connection. In this way, when the first reflector 322 is required to be taken out, it is sufficient to disassemble the second clamping member 3212 from the first clamping member 3211 to improve the disassembly convenience.

In some embodiments, the first reflector 322 is arranged at an inclination relative to a direction of the light path of the incident light R1.

In some embodiments, an angle α1 between the first reflector 322 and the direction of the light path of the incident light R1 is 30°˜60°, i.e., 30°≤α1≤60°. For example, in the embodiments, the direction of the light path of the incident light R1 and the direction of the light path of the reflected light R2 are perpendicular to each other, then α1=45°.

Referring together to FIG. 2, FIG. 5, and FIG. 8, FIG. 8 is a perspective structural schematic view of the second reflector assembly 33 in FIG. 2. The second reflector assembly 33 is disposed on a side of the base plate assembly 20 away from the first reflector assembly 32 and is disposed on the light path of the reflected light R2 to cause the second reflector assembly 33 to receive the reflected light R2 and emit a first diffused light R3. In the embodiments, the second reflector assembly 33 is connected to the base plate 22.

The second reflector assembly 33 includes a diffusion mechanism 331 and a second reflector mechanism 332. The diffusion mechanism 331 is disposed on the light path of the reflected light R2 to cause the reflected light R2 to pass through the diffusion mechanism 331 and form a second diffused light R4. The second reflector mechanism 332 is disposed on a light path of the second diffused light R4 to cause the second reflector mechanism 332 to receive the second diffused light R4 and emit the first diffused light R3.

The second reflector mechanism 332 includes a second reflector holder 332a and a second reflector 332b. The second reflector 332b is arranged on the second reflector holder 332a and defines a diffusion space 106 in communication with the first light outlet 101 with the second reflector holder 332a. The diffusion mechanism 331 is disposed within the diffusion space 106. That is to say, the reflected light R2 passes through the first light outlet 101 and is directed to the diffusion space 106, and the diffusion mechanism 331 within the diffusion space 106 receives the reflected light R2, such that the reflected light R2 passes through the diffusion mechanism 331 to form the second diffused light R4.

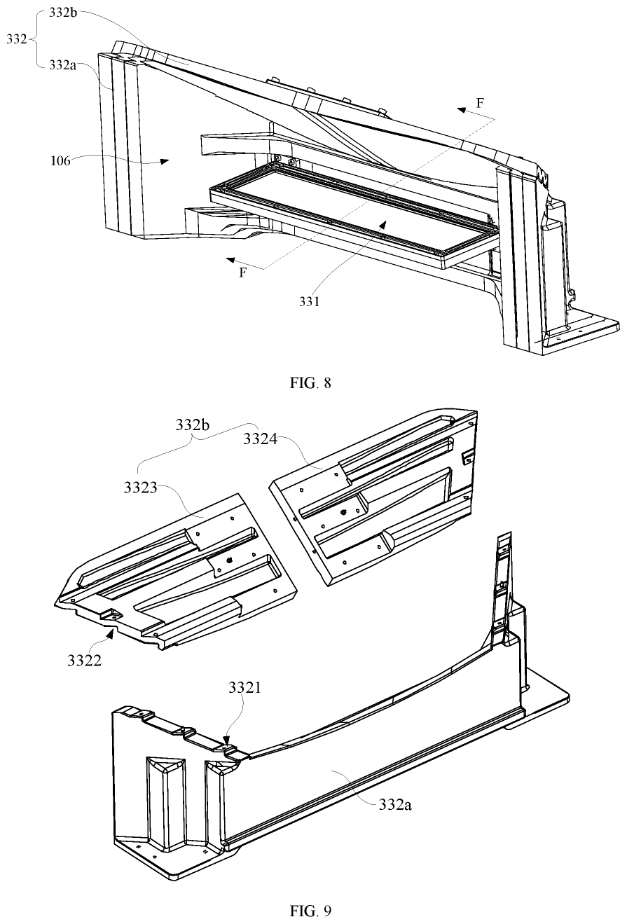

Referring to FIG. 9, FIG. 9 is a schematic view of a disassembled structure of the second reflector holder 332a in FIG. 8. The second reflector holder 332a is arranged with a first positioning portion 3321, and the second reflector 332b is arranged with a second positioning portion 3322. The second positioning portion 3322 is arranged in cooperation with the first positioning portion 3321, such that the second reflector 332b is arranged on the second reflector holder 332a.

In some embodiments, one of the first positioning portion 3321 and the second positioning portion 3322 is a positioning protrusion, and the other of the first positioning portion 3321 and the second positioning portion 3322 is a positioning groove. In the embodiments as an example, the first positioning portion 3321 is a positioning protrusion, and the second positioning portion 3322 is a positioning groove.

In the embodiments, the positioning protrusion of the first positioning portion 3321 is arranged in the form of a step, such that the second reflector 332b can be directly arranged on the second reflector holder 332a.

In some embodiments, the second reflector 332b includes a first reflector block 3323 and a second reflector block 3324, with the first reflector block 3323 and the second reflector block 3324 being spliced together.

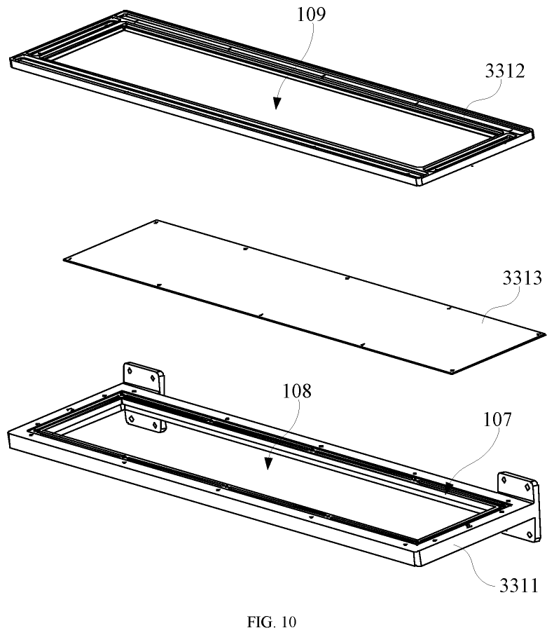

Referring to FIG. 10, FIG. 10 is a schematic view of a disassembled structure of the diffusion mechanism 331 in FIG. 8. The diffusion mechanism 331 includes a carrier member 3311, a cover plate 3312, and a diffusion sheet 3313. The carrier member 3311 is connected to the second reflector holder 332a and defines a mounting groove 107 and a light entry port 108 in communication with the mounting groove 107. The diffusion sheet 3313 is disposed in the mounting groove 107. The cover plate 3312 is arranged covering the mounting groove 107 and defines a light transmission port 109. The reflected light R2 is directed to the diffusion sheet 3313 through the light entry port 108 and forms the second diffused light R4, and the second diffused light R4 is directed to the second reflector 332b through the light transmission port 109.

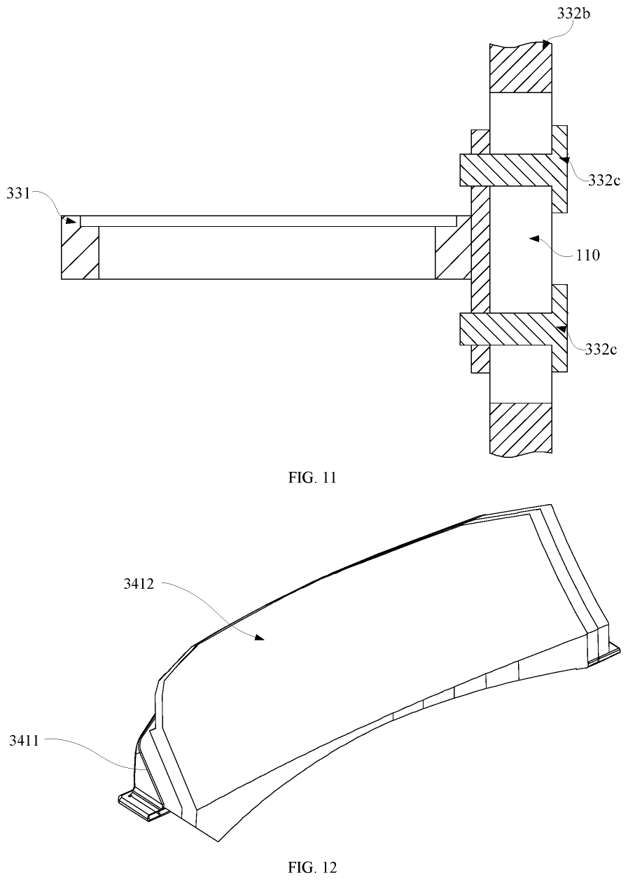

Referring to FIG. 11, FIG. 11 is a cross-sectional schematic view of the diffusion mechanism 331 and the second reflector holder 332a in FIG. 10 in an F-F upward direction. The diffusion mechanism 331 is connected to the second reflector holder 332a and is in an adjustable setting with the second reflector holder 332b.

Specifically, the second reflector holder 332a defines an adjustment groove 110, and the second reflector mechanism 332 further includes a fastener 332c, the fastener 332c being threaded through the adjustment groove 110 to the diffusion mechanism 331.

In some embodiments, the adjustment groove 110 is arranged extending along an opening direction of the first light outlet 101 to enable the fastener 332c to adjust a distance between the diffusion mechanism 331 and the first light outlet 101.

Referring to FIG. 2, FIG. 5, and FIG. 12 together, FIG. 12 is a perspective structural schematic view of a third reflector mechanism 341 in FIG. 2. The third reflector assembly 34 and the second reflector assembly 33 are disposed on a same side of the base plate assembly 20 and are disposed on the light path of the first diffused light R3, so as to enable the third reflector assembly 34 to receive the first diffused light R3 and form a projected image.

Specifically, the third reflector assembly 34 includes a third reflector mechanism 341 and a polarizing assembly 342. The third reflector mechanism 341 is disposed on the light path of the first diffused light R3, so as to enable the third reflector mechanism 341 to receive the first diffused light R3 and emit a third diffused light R5. The polarizing assembly 342 is disposed on a light path of the third diffused light R5, so as to enable the third diffused light R5 to pass through the polarizing assembly 342 and form the projected image.

The third reflector mechanism 341 includes a third reflector holder 3411 and a third reflector 3412. The third reflector 3412 is arranged on the third reflector holder 3411, and the third reflector 3412 is disposed on the light path of the first diffused light R3.

A side of the third reflector 3412 towards directions of light paths of the first diffused light R3 and the third diffused light R5 is arranged with a curved surface.

In some embodiments, an angle α2 between the direction of the light path of the first diffused light R3 and the direction of the light path of the third diffused light R5 is acute.

In some embodiments, the direction of the light path of the reflected light R2 is set parallel to the direction of the light path of the third diffused light R5, i.e., the direction of the light path of the second diffused light R4 is set parallel to the direction of the light path of the third diffused light R5.

Referring further to FIG. 2, the polarizing assembly 342 includes an upper shell 3421 and a polarizer 3422. The upper shell 3421 defines a holding space (not shown) and a mounting port (not shown) in communication with the holding space. The third reflector mechanism 341 is disposed within the holding space, and the polarizer 3422 is arranged covering the mounting port and is disposed on the light path of the third diffused light R5.

In some embodiments, a projected area of the third reflector 3412 on the polarizer 3422 is less than or equal to a planar area of the polarizer 3422, such that all of the third diffused light R5 can pass through the polarizer 3422 and form the projected image.

In some embodiments, the polarizer 3422 is in an adjustable setting with the upper shell 3421, such that the position of the polarizer 3422 can be adjusted according to actual situations to improve the utilization rate of the third diffused lights R5 in practical application.

Referring further to FIG. 2, the light path apparatus 30 may further include a bottom shell 35. The bottom shell 35 is connected to the base 21 and defines an installation space 35a, and the light source assembly 31 and the first reflector assembly 32 are disposed in the installation space 35a.

A spacing portion 351 is arranged on a side of the bottom shell 35 near the installation space 35a to separate the installation space 35a, for defining a first subspace 351a and a second subspace 351b. The light source assembly 31 is disposed in the first subspace 351a, and the first reflector assembly 32 is disposed in the second subspace 351b.

The spacing portion 351 defines a third light outlet 3511 in communication with the first subspace 351a and the second subspace 351b, respectively, so as to cause the incident light R1 emitted from the light source assembly 20 to be directed to the first reflector assembly 32 through the second light outlet 103 and the third light outlet 3511 in sequence.

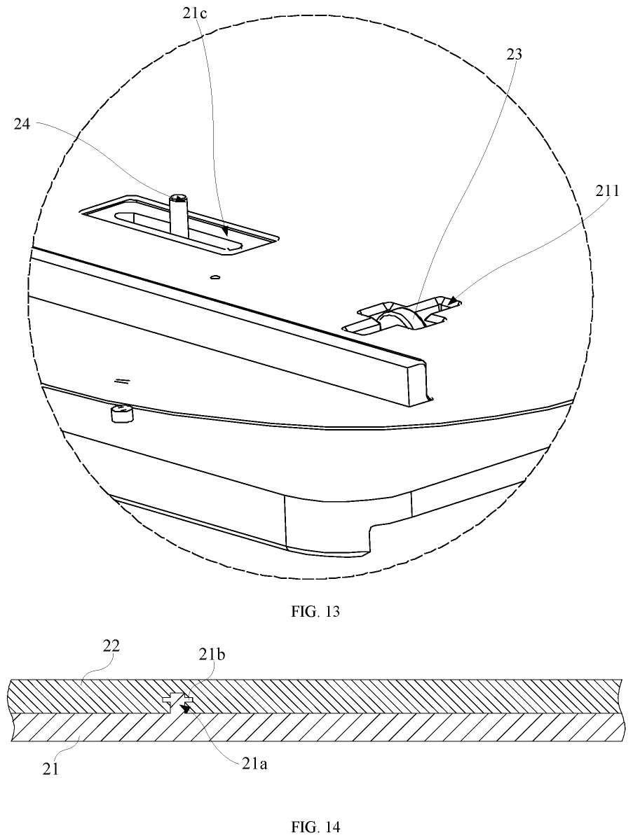

Referring to FIG. 13, FIG. 13 is an enlarged schematic view of part M in FIG. 4. The base plate 22 is movably disposed relative to the base 21 to enable adjustment of a receiving position of the second reflector assembly 33 for receiving the reflected light R2 when the base plate 22 is moved relative to the base 21, thereby adjusting a display region of the projected image and avoiding the problem of the projected image being unable to be displayed.

For example, when the reflected light R2 is directed to the center of the diffusion sheet 3313, the projected image can be displayed in full. If the position of the reflected light R2 directed to the diffusion sheet 3313 is deviated, a part of the diffusion sheet 3313 will not be able to diffuse the reflected light R2, which results in the projected image not being displayed in full. Therefore, the adjustment by the aforesaid way can make the reflected light R2 to be able to directed to the center of the diffusion sheet 3313.

The base plate assembly 20 may further include a rolling member 23. The rolling member 23 is disposed between the base plate 22 and the base 21 to cause the rolling member 23 to rotate relative to the base 21 when the base plate 22 is moved relative to the base 21, thereby reducing the resistance that the base plate 22 is subjected to when it is moved relative to the base 21.

The base 21 defines a mounting groove 211, the rolling member 23 is disposed in the mounting groove 211 and protrudes from the base 21, and the base plate 22 is arranged on the rolling member 23.

In some embodiments, the number of the rolling members 23 is plural, and the rolling members 23 are arranged centrally symmetrically relative to a symmetry center of the base plate 21, so as to improve the smoothness of the movement process of the base plate 22.

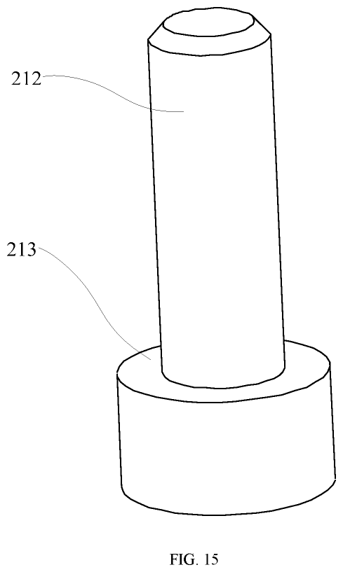

Referring to FIG. 13, FIG. 14, and FIG. 15 together, FIG. 14 is a cross-sectional schematic view of the base 21 and the base plate 22 in FIG. 3 in an N-N upward direction, and FIG. 15 is a perspective structural schematic view of a limiting member 24 in FIG. 13. In some embodiments shown in FIG. 14, one of the base 21 and the base plate 22 is arranged with a first guide portion 21a, and the other of the base 21 and the base plate 22 is arranged with a second guide portion (not identified in FIG. 14). The first guide portion 21a is arranged in cooperation with the second guide portion to provide guidance for the base plate 22 when it moves relative to the base 21.

One of the first guide portion 21a and the second guide portion is a guiding groove, and the other of the first guide portion 21a and the second guide portion is a guiding protrusion. In FIG. 14, the first guide portion 21a is a guiding protrusion and the second guide portion is a guiding groove, which are illustrated as an example.

In some embodiments, one of the first guide portion 21a and the second guide portion serving as the guiding slot is arranged with a first snap-fit portion (not shown), and the guiding protrusion is arranged with a second snap-fit portion 21b. The first snap-fit portion and the second snap-fit portion 21b are in a snap-fit arrangement to provide a guiding effect for the base plate 22 when it is moved relative to the base 21 while improving the smoothness of the moving process.

In some embodiments as shown in FIG. 13, the base assembly 20 further includes a limiting member 24 connected to one of the base 21 and the base plate 22, and the other of the base 21 and the base plate 22 is arranged with a limiting portion 21c. The limiting member 24 is arranged in cooperation with the limiting portion 21c.

In the embodiments, the limiting portion 21c is a limiting groove, and the limiting groove extends towards the movement direction of the base plate 22.

As shown in FIG. 15, the limiting member 24 includes a connection body 212 and a limiting body 213. The connection body 212 is connected to one of the base 21 and the base plate 22 and passes through the limiting groove, and the limiting body 213 is connected to the connection body 212 on a side of the other of the base 21 and the base plate 22 that is far away from the one of the base 21 and the base plate 22. In the embodiments, the connection body 212 passes through the limiting groove and is connected to the base plate 22, and the limiting body 213 is connected to the connection body 212 on the side of the base 21 away from the base plate 22.

Further, the base plate assembly 20 may further include a rocker handle 25, the rocker being connected to the base 21 and the base plate 22, respectively, to enable the rocker handle 25 to drive the base plate 22 to move relative to the base 21 when the rocker handle 25 is rotated.

In some embodiments, the number of the rocker handles 25 may be one or plural, and when the number of rocker handles 25 is plural, the rocker handles 25 are arranged on different sides of the base plate 22.

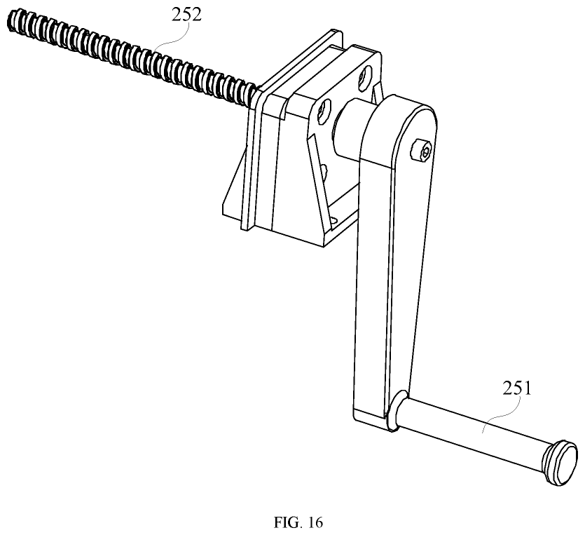

Referring to FIG. 16, FIG. 16 is a perspective structural schematic view of the rocker handle in FIG. 3. The rocker handle 25 includes a rocker body 251 and a filament rod body 252. The rocker body 251 is rotatably connected to the base 21, and the filament rod body 252 is fixedly connected to the rocker body 251 and passes through the base plate 22, so as to cause the base plate 22 to be moved in an extension direction of the filament rod body 252 when the rocker body 251 is rotated relative to the base 21.

The limiting groove as the limiting portion 21c is arranged extending along an extension direction of the filament rod body 252.

The extension length of the limiting groove is less than or equal to the extension length of the filament rod body 252, such that the limiting groove can restrict the travel of the filament rod body 252, thereby restricting the travel of the movement of the base plate 22.

Distinguished from the related art, the head-up display device provided by the present embodiments includes: abase plate assembly, defining a first light outlet; a light source assembly, connected to the base plate assembly and configured to emit an incident light; a first reflector assembly, disposed on a same side of the base plate assembly as the light source assembly and on a light path of the incident light, so as to enable the first reflector assembly to receive the incident light and emit a reflected light directed toward the first light outlet; a second reflector assembly, disposed on a side of the base plate assembly away from the first reflector assembly and on a light path of the reflected light, so as to enable the second reflector assembly to receive the reflected light and emit a first diffused light; and a third reflector assembly, disposed on a same side of the base plate assembly as the second reflector assembly and disposed on a light path of the first diffused light, so as to enable the third reflector assembly to receive the first diffused light and form a projected image. In the above way, the second reflector assembly and the third reflector assembly are not required to be arranged on the light path of the light source assembly, avoiding the problem of the head-up display device having a large size in the direction of the light path of the light source.

The foregoing is only a part of the embodiments of the present disclosure, and is not intended to limit the scope of the present disclosure. Any equivalent device or equivalent process transformation utilizing the contents of the specification and the accompanying drawings of the present disclosure, or directly or indirectly applying them in other related technical fields, are all similarly included in the scope of the present disclosure.

What is claimed is:

1. A head-up display device for rail transportation, comprising:
a base plate assembly, defining a first light outlet;
a light source assembly, connected to the base plate assembly and configured to emit an incident light;
a first reflector assembly, disposed on a same side of the base plate assembly as the light source assembly and on a light path of the incident light, so as to enable the first reflector assembly to receive the incident light and emit a reflected light directed toward the first light outlet;
a second reflector assembly, disposed on a side of the base plate assembly away from the first reflector assembly and on a light path of the reflected light, so as to enable the second reflector assembly to receive the reflected light and emit a first diffused light; and
a third reflector assembly, disposed on a same side of the base plate assembly as the second reflector assembly and disposed on a light path of the first diffused light, so as to enable the third reflector assembly to receive the first diffused light and form a projected image.

2. The head-up display device according to claim 1, wherein the base plate assembly comprises abase and a base plate; the base defines a first sub-port, the light source assembly is connected to the base, and the base plate is disposed on a side of the base away from the light source assembly and defines a second sub-port; the first sub-port and the second sub-port together define the first light outlet; the second reflector assembly and the third reflector assembly are connected to the base plate respectively.

3. The head-up display device according to claim 2, wherein the base plate is movably disposed relative to the base, to enable adjustment of a light position and/or a light angle of the first diffused light when the base plate is moved relative to the base.

4. The head-up display device according to claim 3, wherein the base plate assembly further comprises a rocker handle, the rocker being connected to the base and the base plate, respectively, so as to enable the rocker handle to drive the base plate to move relative to the base when the rocker handle is rotated.

5. The head-up display device according to claim 4, wherein the rocker handle comprises a rocker body and a filament rod body; the rocker body is rotatably connected to the base, and the filament rod body is fixedly connected to the rocker body and passes through the base plate, so as to enable the base plate to move in an extension direction of the filament rod body when the rocker body is rotated relative to the base.

6. The head-up display device according to claim 1, wherein the first reflector assembly comprises a first reflector holder and a first reflector; the first reflector holder is disposed on a same side of the base plate assembly as the light source assembly and connected to the base plate assembly; the first reflector is arranged on the first reflector holder and is disposed on the light path of the incident light.

7. The head-up display device according to claim 6, wherein the first reflector is arranged at an inclination relative to a direction of the light path of the incident light.

8. The head-up display device according to claim 1, wherein the second reflector assembly comprises a diffusion mechanism and a second reflector mechanism; the diffusion mechanism is disposed on the light path of the reflected light to cause the reflected light to pass through the diffusion mechanism and form a second diffused light; the second reflector mechanism is disposed on a light path of the second diffused light, so as to enable the second reflector mechanism to receive the second diffused light and emit the first diffused light.

9. The head-up display device according to claim 8, wherein the second reflector mechanism comprises a second reflector holder and a second reflector; the second reflector is arranged on the second reflector holder and defines a diffusion space, that is in communication with the first light outlet, with the second reflector holder; the diffusion mechanism is disposed within the diffusion space.

10. The head-up display device according to claim 1, wherein the third reflector assembly comprises a third reflector mechanism and a polarizing assembly; the third reflector mechanism is disposed on the light path of the first diffused light, so as to enable the third reflector mechanism to receive the first diffused light and emit a third diffused light; the polarizing assembly is disposed on a light path of the third diffused light, to cause the third diffused light to pass through the polarizing assembly and form the projected image.
